(19) United States
(12) Patent Application Publication
(10) Pub. No.: US 2016/0347027 A1
(43) Pub. Date: Dec. 1, 2016

(54) Spliceable Resilient Pad Assembly

(71) Applicant: Han-Chuan Chen, Taichung City (TW)

(72) Inventors: Han-Chuan Chen, Taichung City (TW); Su-Hsia Wang, Taichung City (TW)

(21) Appl. No.: 14/722,217

(22) Filed: May 27, 2015

(51) Int. Cl. B32B 3/26; B32B 3/30

(52) U.S. Cl. CPC B32B 3/266; B32B 3/30; B32B 2307/56; B32B 2437/02; B32B 2437/04

(57) ABSTRACT

A resilient pad assembly has multiple pad bodies connected with each other to form a two-layer pad structure including a first layer and a second layer. Each pad body has a first side, a second side, and multiple damping bodies protruding from the first side and arranged in a matrix form. Each damping body has a hollow post, a recess, and multiple vents. The hollow post protrudes from the first side of the pad body and has a surrounding surface and a free end provided with a contact surface. The recess is defined in the second side of the pad body. The vents are defined through the surrounding surface of the post and communicate with the recess.

### BACKGROUND OF THE INVENTION

1. Field of the Invention

The present invention relates to a resilient pad assembly, and more particularly to a spliceable resilient pad assembly having excellent ventilation and a reduced weight.

2. Description of Related Art

A conventional resilient pad, such as a shoe pad, is formed with a specific mold having a specific shape and size, so the conventional resilient pad has a specific shape and size. Therefore, the cost for manufacturing multiple resilient pads in different shapes and sizes is high. TW Utility Model No. M471825, entitled “ Spliceable Resilient Pad Assembly,” is provided to solve the problems of the conventional resilient pad.

The resilient pad assembly of the '825 Patent comprises at least one extension unit each composed of multiple pad bodies connected with each other. Each pad body has multiple posts and recesses for connection with the other pad bodies. With such an arrangement, a resilient pad having a desired shape and size can be provided by connecting the pad bodies. Accordingly, the cost for manufacturing the resilient pad assembly can be reduced.

However, the posts and recesses of each pad body of the '825 Patent have a closed surface, so the ventilation of the resilient pad assembly of the '825 Patent is insufficient. When the resilient pad assembly is applied in an environment or an object without ventilation, such as shoes or helmets, the user is easily discomforted.

To overcome the shortcomings, the present invention tends to provide a resilient pad assembly to mitigate or obviate the aforementioned problems.

### SUMMARY OF THE INVENTION

The main objective of the invention is to provide a resilient pad assembly having excellent ventilation and a reduced weight.

The resilient pad assembly has multiple pad bodies connected with each other to form a two-layer pad structure including a first layer and a second layer. Each pad body has a first side, a second side, and multiple damping bodies protruding from the first side and arranged in a matrix form. Each damping body has a hollow post, a recess, and multiple vents. The hollow post protrudes from the first side of the pad body and has a surrounding surface and a free end provided with a contact surface. The recess is defined in the second side of the pad body. The vents are defined through the surrounding surface of the post and communicate with the recess.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a resilient pad assembly in accordance with the present invention;

FIG. 2 is an exploded perspective view of the resilient pad assembly in FIG. 1;

FIG. 3 is a side view of a second embodiment of a resilient pad assembly in accordance with the present invention;

FIG. 4 is a perspective view of a third embodiment of a resilient pad assembly in accordance with the present invention;

FIG. 5 is a perspective view of a fourth embodiment of a resilient pad assembly in accordance with the present invention;

FIG. 6 is a perspective view of a fifth embodiment of a resilient pad assembly in accordance with the present invention; and

FIG. 7 is a cross sectional side view of the resilient pad assembly in FIG. 6.

### DETAILED DESCRIPTION OF PREFERRED EMBODIMENT

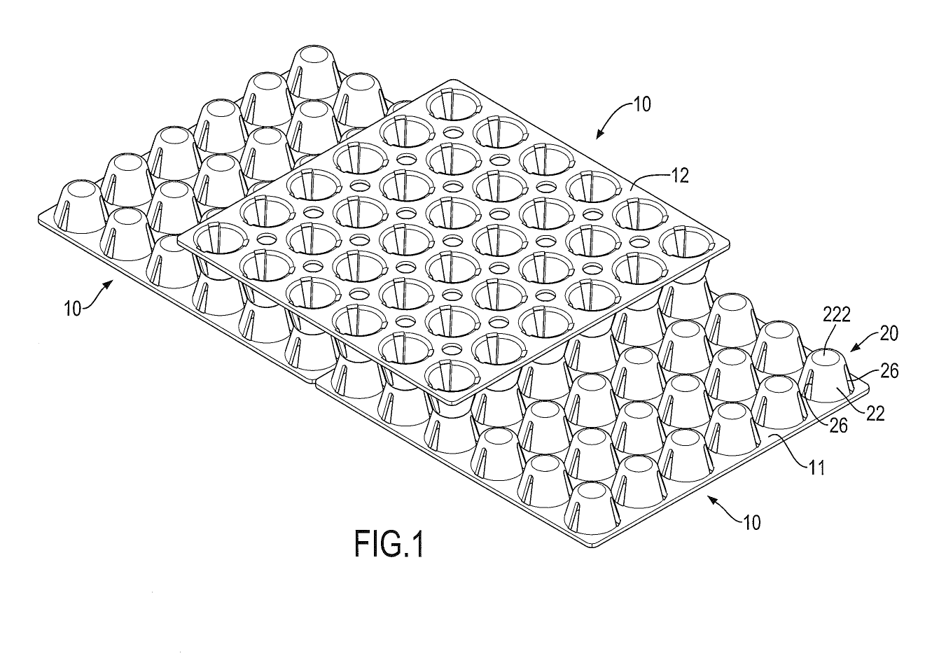

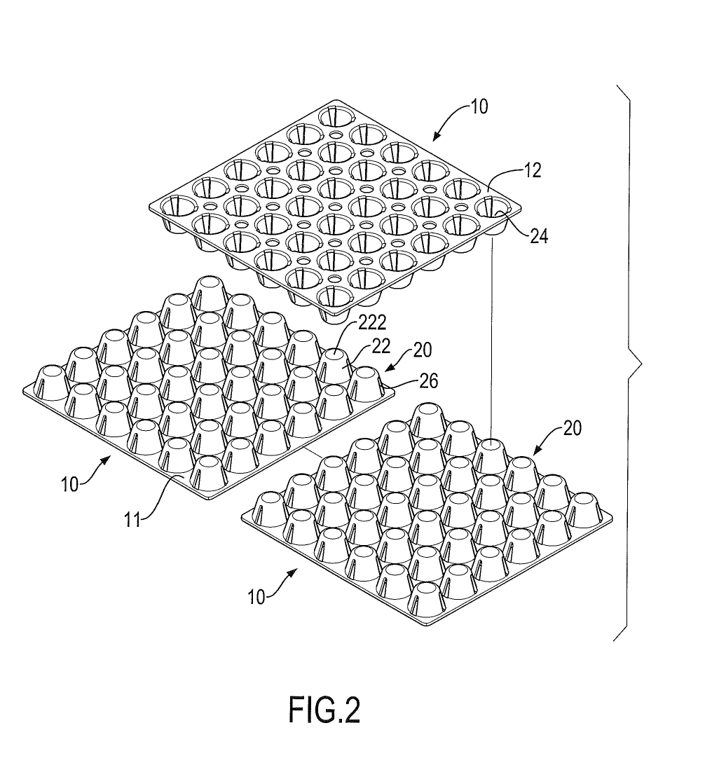

With reference to FIGS. 1 to 3, a resilient pad assembly in accordance with the present invention comprises multiple pad bodies 10 connected with each other to form a two-layer pad structure including a first layer and a second layer. Each pad body 10 is made of a resilient material, has a rectangular or other possible shape, and comprises a first side 11, a second side 12, and multiple damping bodies 20 protruding from the first side and arranged in a matrix form. Each damping body 20 comprises a post 22, a recess 24, and multiple vents 26. The post 22 is hollow, protrudes from the first side 11 of the pad body 10, and has a surrounding surface and a free end provided with a contact surface 222. The recess 24 is defined in the second side 12 of the pad body 10. The vents 26 are defined through the surrounding surface and communicating with the recess 24. Preferably, each post 22 has three vents 26, and the three vents 26 of each post 22 are arranged at even intervals around the surrounding surface of the post 22.

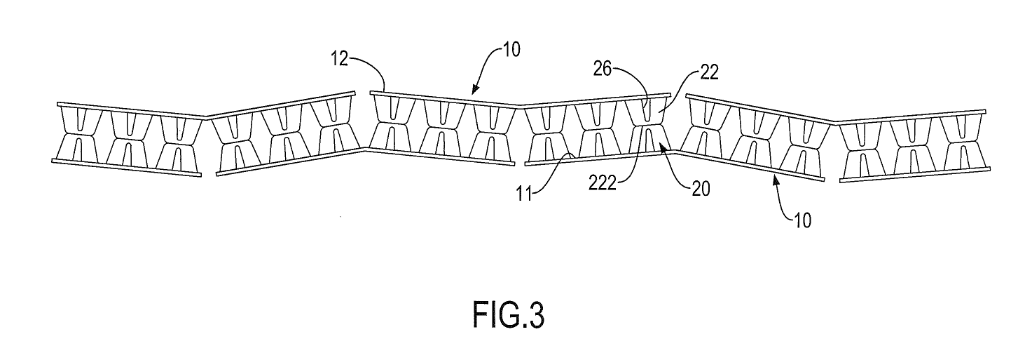

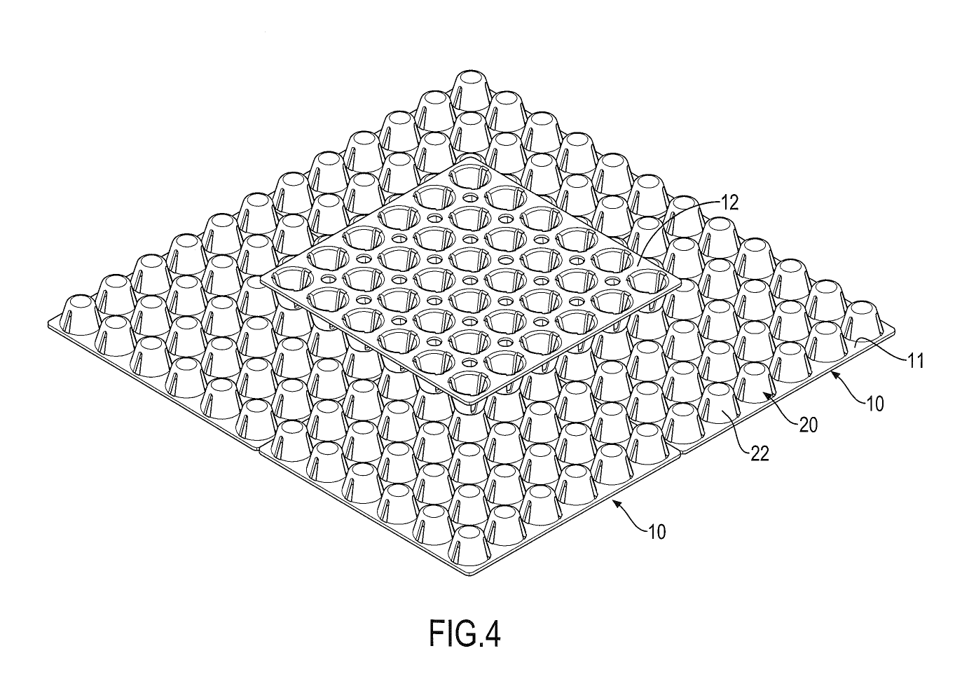

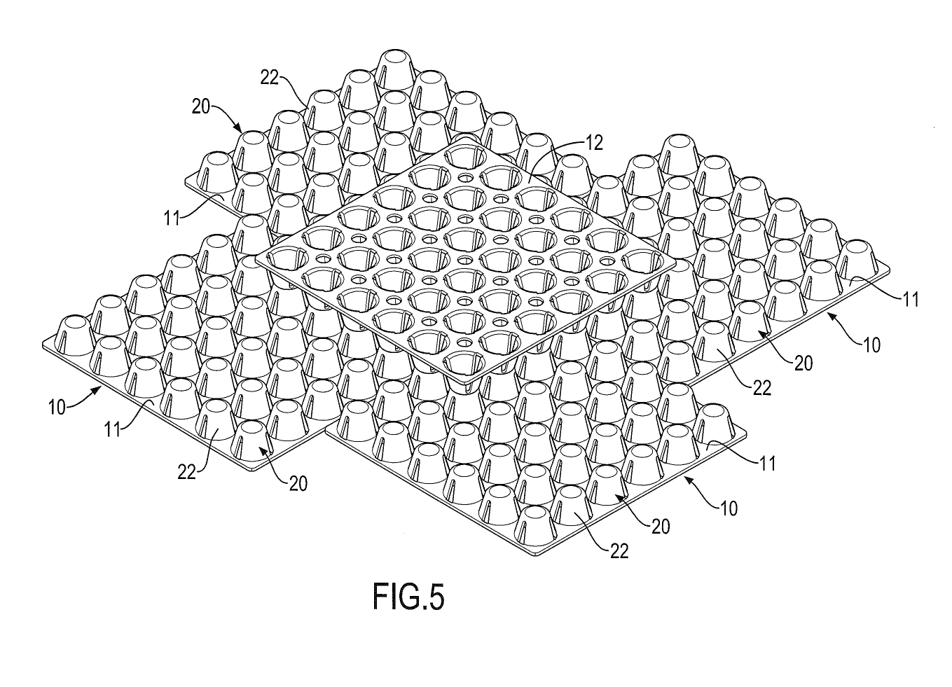

To splice the pad bodies 10, with reference to FIGS. 1 and 3 to 5, the first sides 11 of the pad bodies 10 on the first and second layers face each other first, and the contact surfaces 222 of some of the posts 20 of the pad body 10 of the first layer respectively abut the contact surfaces 222 of some of the posts 20 of the pad body 10 of the second layer. Preferably, with reference to FIGS. 1 and 3, half of the posts 22 on the pad body 10 of the first layer are aligned with half of the posts 22 of the pad body 10 of the second layer, and the other half of the posts 22 on the pad body 10 of the first layer are aligned with half of the posts 22 of another pad body 10 of the second layer. Alternatively, with reference to FIG. 4 or 5, the posts 22 of the pad body 10 of the first layer are divided into four segments, and the four segments of the posts 22 of the pad body 10 of the first layer are aligned respectively with multiple posts 22 of four pad bodies 10 on the second layer. Then, the contact surfaces 222 of the posts 22 of the pad bodies 10 on the first and second layers are securely connected with each other by glue, ultrasonic welding, or thermo welding. Accordingly, the pad bodies 10 on the first and second layers are connected securely with each other to form a resilient pad assembly in a large size. Most of the resilient pad assembly has a two-layer structure to provide sufficient supporting strength. In addition, the resilient pad assembly may have several single-layer structures on the periphery of the pad assembly. Additional pad bodies 10 can be cut to desired sizes to fit and connect with the single-layer structures of the pad assembly, such that all of the pad assembly has a two-layer structure. Alternatively, the single-layer structures can be cut off from the pad assembly to make the pad assembly have a two-layer structure in even thickness.

With such an arrangement, the resilient pad assembly in accordance with the present invention is composed of multiple pad bodies 10 connected with each other. Thus, multiple resilient pad assemblies in different sizes and shapes can be formed by connecting the pad bodies 10 in different ways and are cut into desired shapes and sizes by cutters. Therefore, the cost for manufacturing the resilient pad assembly can be effectively reduced. In addition, with the vents 26 formed in the posts 22 and communicating with the recesses 24, the ventilation of the resilient pad assembly is excellent and the weight of the resilient pad assembly can be effectively reduced. When the resilient pad assembly is applied to an environment or an objection without ventilation, such as shoes or helmets, the comfort of wearing these objects can be improved. Furthermore, with the arrangement of the vents 26, the damping bodies 20 have preferred softness, so the resilient pad assembly has both of excellent structural strength and resilience.

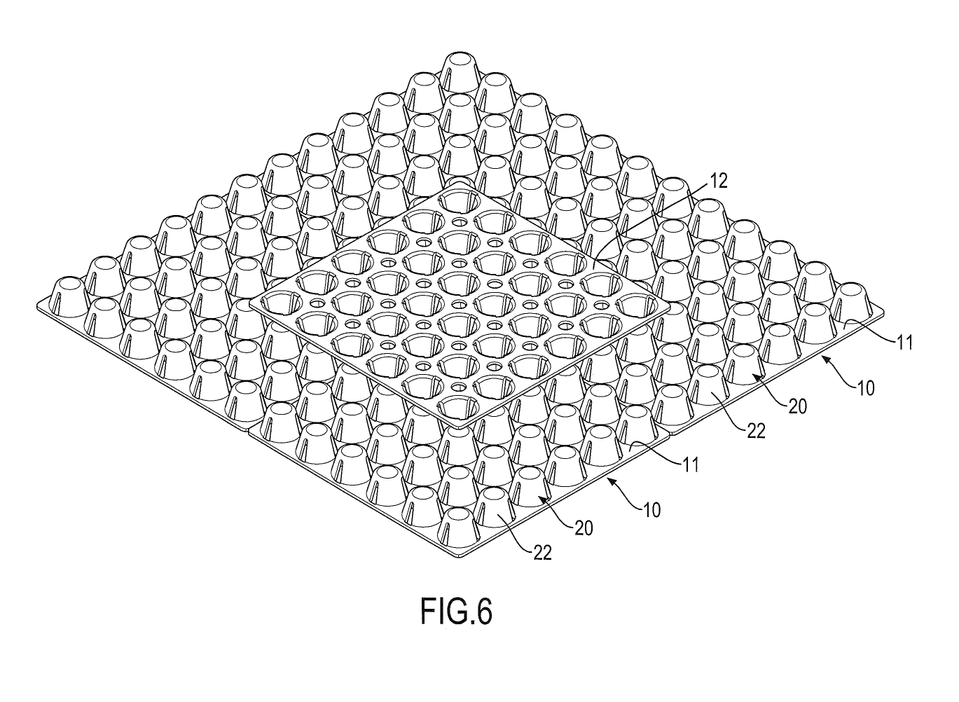

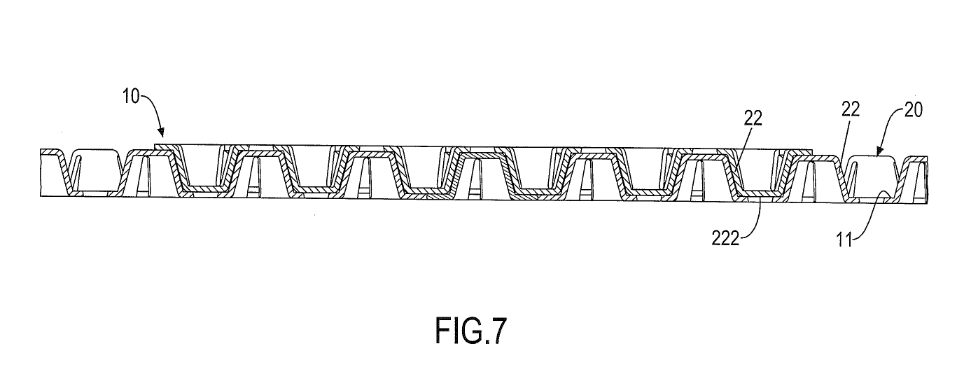

With reference to FIGS. 6 and 7, to connect the pad bodies 10, the posts 22 of each pad body 10 of the first layer are inserted into spaces formed between the posts 22 of a corresponding pad body 10 of the second layer. The contact surfaces 222 on the posts 22 of each pad body 10 on the first layer can be connected with and abut the first side 11 of a corresponding pad body 10 of the second layer. The pad bodies 10 are then connected securely with each other by glue, ultrasonic welding, or thermo welding. Accordingly, a resilient pad assembly having a compact structure and an enhanced structural strength is provided, and the resilient pad assembly is not easily bent, thereby fitting different needs.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A resilient pad assembly comprising:
multiple pad bodies connected with each other to form a two-layer pad structure including a first layer and a second layer, and each pad body comprising
a first side;
a second side; and
multiple damping bodies protruding from the first side and arranged in a matrix form, and each damping body comprising
a hollow post protruding from the first side of the pad body and having a surrounding surface and a free end provided with a contact surface;
a recess defined in the second side of the pad body; and
multiple vents defined through the surrounding surface of the post and communicating with the recess.

2. The resilient pad assembly as claimed in claim 1, wherein the post of each damping body has three vents.

3. The resilient pad assembly as claimed in claim 2, wherein the three vents of the post of each damping body are arranged at even intervals around the surrounding surface of the post.

4. The resilient pad assembly as claimed in claim 3, wherein the contact surfaces on the posts of each pad body on the first layer are connected with and abut the contact surfaces on the posts of a corresponding pad body on the second layer.

5. The resilient pad assembly as claimed in claim 1, wherein the contact surfaces on the posts of each pad body on the first layer are connected with and abut the contact surfaces on the posts of each pad body on the second layer.

6. The resilient pad assembly as claimed in claim 3, wherein the posts of each pad body on the first layer are inserted into spaces formed between the posts of a corresponding pad body on the second layer.

7. The resilient pad assembly as claimed in claim 6, wherein the contact surfaces on the posts of each pad body on the first layer are connected with and abut the first side of a corresponding pad body on the second layer.

8. The resilient pad assembly as claimed in claim 1, wherein the posts of each pad body on the first layer are inserted into spaces formed between the posts of a corresponding pad body on the second layer.

9. The resilient pad assembly as claimed in claim 8, wherein the contact surfaces on the posts of each pad body on the first layer are connected with and abut the first side of the corresponding pad body on the second layer.
